(19) United States
(12) Patent Application Publication
(10) Pub. No.: US 2002/0194012 A1
(43) Pub. Date: Dec. 19, 2002

(54) Automated system for power retailing

(75) Inventors: Takaaki Maekawa, Tokyo (JP); Hirofumi Tanaka, Tokyo (JP); Tadahiro Gouda, Tokyo (JP); Yukitoki Tsukamoto, Tokyo (JP); Marta Marmiroli, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/011,747

(22) Filed: Dec. 11, 2001

(30) Foreign Application Priority Data
Jun. 19, 2001 (JP) 2001-184617

(51) Int. Cl. G06F 17/60

(52) U.S. Cl. 705/1; 705/412

(57) ABSTRACT

Transaction of electric power has been conventionally conducted mainly to cope with power demand of a large-volume customer, and in which a power customer presents a power demand for covering a certain period of time, and power companies tenders for the offer. In this manner, the transaction was done in reliance on manpower.

The invention provides an automated system for power retailing in which: power demand information is transmitted to an intermediary server (31) via a wide area net (4) from a customer server (11) of a power customer 1 consuming power; power supply information including information about charges and capable of being supplied from a company server (21) of a power company; the intermediary server (31) selects an optimum power company (2) for the power customer (1) using those information thereby intermediating the transaction of power; and eventually the power customer (1) can purchase the most inexpensive power.

### BACKGROUND OF THE INVENTION

1. Technical Field

The present invention relates to an automated system for power retailing, used in an electric power transaction market opened due to recent liberalization of power, for the purpose of automating an intermediary business for power retailing (power auction) thereby providing a function that any power customer can easily make a contract with a power company serving the most inexpensive power.

2. Background Art

Hitherto, a power transaction has been mainly made for a power demand of a large-volume customer in the following manner. A power customer proposes their power demand during a certain period of time, and a tender is carried out among power companied to meet the proposed power demand thereby a transaction being made. This transaction may be made directly by the customer, or may be made by intermediation of an intermediary agent between the customer and company. In the United States where liberalization of power becomes popular, there has emerged some company operating a power transaction office that specially deals with such a power transaction business (intermediary agent for power retailing) has emerged.

Whereas, it has been conventional for general individual homes to previously make a contract with a predetermined power company to secure an electric power supply.

In either case, such a transaction has been conventionally made through someone else's hand.

Recently several attempts of applying an automatic measurement to measurement or power transaction have been proposed. First, as a prior art for remotely measuring electric energy, an automatic measurement system of electric energy was disclosed in the Japanese Patent Publication (unexamined) No. 46880/2000. Further, as a prior art for uniformly administrating collection of power charges on the supplied power in an automatic and centralized manner, a sale and purchase system of energy and the like was disclosed in the Japanese Patent Publication (unexamined) No. 20799/2000.

The mentioned known arts are intended to enable collection of information about power supply and demand or collection of money in the form of remote and automatic control, which otherwise would have been conducted manually. However, such known arts makes certainly it possible to conduct storage and administration of information, but they have no technique for automatically selecting a power company most favorable (cost-effective) to the power customer on the basis of obtained information.

Further, as a prior art for transaction between a plurality of power companies and a plurality of power customers, a power distribution control apparatus was disclosed in the Japanese Patent Publication (unexamined) No. 308771/1999. In this control apparatus, a power required by each customer is jointly purchased, and the power is distributed through making an adjustment internally between the customers. This power distribution control apparatus comprises a unit for determining a plurality of power companies from which power is purchased and the power to be purchased, a unit for storing the power purchased from the power company, and a unit for measuring electric energy consumed by each power customer. On the basis of data such as measured electric energy, purchase contract conditions concluded with the power company, and power supply contract conditions concluded with the power customer, the power to be distributed to each power customer is calculated to control power transmission. By using this power distribution control apparatus, a power is transmitted from the power company via the power distribution control apparatus to each power customer. However, since the system is of a centralized type in which all power transmission has to pass through the power distribution control apparatus, modification in the conventional power transmission system will be essentially required. Furthermore, if there arises any abnormal condition in the power distribution control apparatus, all power transmission will be obliged to stop.

As the conventional power transaction has been manually conducted, the following problems exist between each of the persons concerned.

Problems on the Part of Power Customers

(1) A large-volume customer could select a power company at an auction by providing information about power demand personally required. However, individual transactions have required a great deal of labor. Moreover, minute management of costs has required dividing transaction into a number of small volumes.

(2) A small-volume customer could only make a selection from prices previously proposed by the power companies. Further, a selection of the optimum company based on personal information about power demand has required a lot of labor.

Problems on the Part of Power Companies

(1) Tender for the transaction with the large-volume customer has required a series of manual operations, and participation in the auction has required a lot of labor.

(2) To the small-volume customers, only a fixed price could be presented, and a strategic pricing has been difficult.

Problems on the Part of Intermediary Agents for Power Retailing Who Operate a Transaction Office

(1) Since the auction for power has been manually operated, it has required a lot of labor and cost.

(2) Transaction with the small-volume customer could not be carried out resulting in a loss of business chance.

Problems of Conventional Automated Systems

(1) Power transmission route is changed from between the power company and power customer to via the power distribution control apparatus. Therefore, labor and cost such as establishment for facilities of the power distribution control apparatus, construction works for modifications of the route, etc. have been required. Moreover, there has been a possibility of stopping all power transmission, if any abnormal condition of the power distribution control apparatus occurs.

(2) Power for the power customers consuming different amounts of power or consuming power in different time zones was jointly purchased. Therefore, from the standpoint of individual customers, it has been not always possible to select a most favorable power company for each time zone.

### SUMMARY OF THE INVENTION

The invention was made to solve the above-discussed problems. It is a first object of the invention to provide an improved automated system for power retailing capable of performing the following advantages. That is, with this automated system, it is possible for power customers to select the optimum power company for their personal power demand. It is possible for a power company to save a trouble of participating in the auction, and to offer any strategic price to small-volume customers. It is possible for an intermediary agent for power retailing to save a trouble of operating an auction, and provide a service for selecting the optimum power company to small-volume customers.

It is a second object of the invention to provide an automated system for power retailing which needs no modification in the route of power transmission and wherein individual customers can be supplied with power from the most favorable (cost-effective) power company for each time zone.

An automated system for power retailing according to the present invention comprises an intermediary server, to which inputted through a network are power supply information about a power capable of being supplied by a power company including information about electric power charge, and information about power demand that is an information about power consumption of a power customer who consumes power;

in which the mentioned intermediary server, by selecting the mentioned power company suitable for the mentioned power customer on the basis of the mentioned inputted information about power supply and power demand, intermediates a transaction of power between the mentioned power company and the mentioned power customer.

Since the automated system for power retailing according to the invention is arranged as described above, an advantage is performed such that a power company suitable for the power customer can be selected.

It is also preferable that the automated system for power retailing according to the invention further comprises a company server that is connected to the mentioned intermediary server through the mentioned network and transmits the information about power supply of the mentioned power company to the mentioned intermediary server.

Since the automated system for power retailing according to the invention is arranged as described above, an advantage is performed such that the information about power supply can be transmitted to the intermediary server by the company server.

It is also preferable that the automated system for power retailing according to the invention further comprises a customer server that is connected to the mentioned intermediary server through the mentioned network, includes power consumption measurement means for measuring a power consumption of the power customer, and transmits information about the power consumption measured by the mentioned power consumption measurement means to the mentioned intermediary server.

Since the automated system for power retailing according to the invention is arranged as described above, an advantage is performed such that the information about power demand can be transmitted to the intermediary server by the customer server.

In the automated system for power retailing according to the invention, it is preferable that the mentioned power consumption measurement means includes: measurement means for measuring at intervals of a predetermined length an amount of power consumed by the power customer; and communication means for transmitting the information about the power consumption measured by the mentioned measurement means to the mentioned intermediary server.

Since the automated system for power retailing according to the invention is arranged as described above, an advantage is performed such that the information about power demand can be transmitted to the intermediary server at intervals of a predetermined length.

In the automated system for power retailing according to the invention, it is preferable that the mentioned power consumption measurement means includes: measurement means for measuring at intervals of an arbitrary length an amount of power consumed by the power customer; and communication means for transmitting at intervals of a predetermined length the information about the power consumption measured by the mentioned measurement means to the mentioned intermediary server.

Since the automated system for power retailing according to the invention is arranged as described above, an advantage is performed such that the information about the power consumption measured at intervals of arbitrary length can be transmitted to the intermediary server at intervals of a predetermined length.

In the automated system for power retailing according to the invention, it is preferable that the mentioned power consumption measurement means includes: measurement means for measuring at intervals of an arbitrary length an amount of power consumed by the power customer; recording means for recording information about the power consumption measured by the mentioned measurement means; and communication means for transmitting in a predetermined block the information about the power consumption recorded by the mentioned recording means to the mentioned intermediary server.

Since the automated system for power retailing according to the invention is arranged as described above, an advantage is performed such that the information about power demand can be transmitted to the intermediary server in a predetermined block.

In the automated system for power retailing according to the invention, it is preferable that the mentioned power supply information contains a unit price of power charges corresponding to an amount of power generated by the power company; the mentioned power customers are plural; and the mentioned intermediary server selects a power company on the basis of a total amount of the power consumption of the mentioned plural power customers.

Since the automated system for power retailing according to the invention is arranged as described above, an advantage is performed such that a more inexpensive power company can be selected based on the total amount of the power consumption of a plurality of power customers.

In the automated system for power retailing according to the invention, it is preferable that the mentioned intermediary server selects a power company for each divided section of time period of the mentioned power customers.

Since the automated system for power retailing according to the invention is arranged as described above, an advantage is performed such that a more inexpensive power company can be selected exactly for each divided section of time period of the power customer.

In the automated system for power retailing according to the invention, it is preferable that the mentioned power supply information contains a unit price of power charges set for each time zone of the mentioned power company; and the mentioned intermediary server, based on the unit price of power charges for each time zone of the mentioned power company, selects a power company for each divided section of time period of the mentioned power customer.

Since the automated system for power retailing according to the invention is arranged as described above, an advantage is performed such that a more inexpensive power company can be selected based on a unit price of power charges for each time zone, exactly for each divided section of time period of the power customer.

In the automated system for power retailing according to the invention, it is preferable that service information is set individually for the mentioned power customer and the mentioned intermediary server selects a power company by using the service information set individually for the mentioned power customer.

Since the automated system for power retailing according to the invention is arranged as described above, an advantage is performed such that a more appropriate power company can be selected using the service information set individually at each power customer.

In the automated system for power retailing according to the invention, it is preferable that the mentioned intermediary server selects a power company by a selection method corresponding to the power consumption of the mentioned power customer.

Since the automated system for power retailing according to the invention is arranged as described above, an advantage is performed such that an appropriate power company corresponding to the power consumption can be selected.

In the automated system for power retailing according to the invention, it is preferable that the mentioned power supply information contains a unit price of power charge corresponding to the amount of power generated by the mentioned power company, the mentioned power customers are plural, and the mentioned intermediary server selects a power company for each divided section of time period of the mentioned power customer for the power customer consuming a large-volume of power based on the total amount of the power consumption of the mentioned plural power customers.

Since the automated system for power retailing according to the invention is arranged as described above, an advantage is performed such that, for the power customer consuming a large-volume of power, by summing up a plurality of power customers, a more inexpensive power company can be selected.

In the automated system for power retailing according to the invention, it is preferable that the mentioned power supply information contains a unit price of power charge set for each time zone of the mentioned power company; and the mentioned intermediary server selects a power company for each divided section of time period of the mentioned power customer for the power customer consuming a small-volume of power based on a unit price of power charges set for each time zone of the mentioned power company.

Since the automated system for power retailing according to the invention is arranged as described above, an advantage is performed such that, for the power customer consuming a small-volume of power, a more inexpensive power company can be selected.

In the automated system for power retailing according to the invention, it is preferable that the service information is set individually for the mentioned power customer, and that the mentioned intermediary sever selects a power company for the power customer consuming a small-volume of power for each divided section of time period of the mentioned power customer using the service information set individually for the mentioned power customer.

Since the automated system for power retailing according to the invention is arranged as described above, an advantage is performed such that for the power customer consuming a small-volume of power, a more inexpensive power company can be selected.

In the automated system for power retailing according to the invention, it is preferable that the mentioned information about power supply contains a table showing a unit price of power charges in which a unit price of power charges is set corresponding to the amount of power generated by the mentioned power company.

Since the automated system for power retailing according to the invention is arranged as described above, an advantage is performed such that a power company can be selected using the table of unit price of power charges corresponding to an amount of power generated by the power company.

In the automated system for power retailing according to the invention, it is preferable that the mentioned information about power supply contains a function for calculating a unit price of power charges based on the amount of power generated by the mentioned power company.

Since the automated system for power retailing according to the invention is arranged as described above, an advantage is performed such that a power company can be selected utilizing the function for calculating a unit price of power charges based on the amount of power generated by the power company.

In the automated system for power retailing according to the invention, it is preferable that the mentioned information about power supply contains a table showing a unit price of power charges set for each time zone.

Since the automated system for power retailing according to the invention is arranged as described above, an advantage is performed such that a power company can be selected using the table of unit price of power charges for each time zone.

In the automated system for power retailing according to the invention, it is preferable that the mentioned information about power supply contains a function for calculating a unit price of power charges with the use of time.

Since the automated system for power retailing according to the invention is arranged as described above, an advantage is performed such that a power company can be selected utilizing the function for calculating a unit price of power charges using time.

In the automated system for power retailing according to the invention, it is preferable that the mentioned information about power demand contains information about location of the mentioned power customer, and the mentioned information about power supply contains information about power transmission cost of the mentioned power company.

Since the automated system for power retailing according to the invention is arranged as described above, an advantage is performed such that a power company can be selected adding a power transmission cost.

In the automated system for power retailing according to the invention, it is preferable that the mentioned intermediary server selects a power company using information about location contained in the mentioned information about power demand and the information about power generation cost contained in the mentioned information about power supply.

Since the automated system for power retailing according to the invention is arranged as described above, an advantage is performed such that a power company can be selected adding a power transmission cost.

### BRIEF DESCRIPTION OF THE DRAWINGS

FIG. 1 is a diagram showing an arrangement of an automated system for power retailing according to a first embodiment of the present invention.

FIG. 2 is a flow chart showing an operation of the automated system for power retailing according to the first embodiment of the invention.

FIG. 3 is a diagram showing an arrangement of a customer server in the automated system for power retailing according to a second embodiment of the invention.

FIG. 4 is a flow chart showing an operation of the customer server in the automated system for power retailing according to the second embodiment of the invention.

FIG. 5 is a diagram showing an arrangement of a customer server in the automated system for power retailing according to a third embodiment of the invention.

FIG. 6 is a flow chart showing an operation of the customer server in the automated system for power retailing according to the third embodiment of the invention.

FIG. 7 is a diagram showing an arrangement of a customer server in the automated system for power retailing according to a fourth embodiment of the invention.

FIG. 8 is a table showing a data format stored in recording means of the customer server in the automated system for power retailing according to the fourth embodiment of the invention.

FIG. 9 is a diagram showing a communication format transmitted by communication means of the customer server in the automated system for power retailing according to the fourth embodiment of the invention.

FIG. 10 is a flow chart showing an operation of the customer server in the automated system for power retailing according to the fourth embodiment of the invention.

FIG. 11 is a diagram showing an arrangement of a customer server in the automated system for power retailing according to a fifth embodiment of the invention.

FIG. 12 is a flow chart showing an operation of the automated system for power retailing according to the fifth embodiment of the invention.

FIG. 13 is a flow chart showing an operation of the customer server in the automated system for power retailing according to the fifth embodiment of the invention.

FIG. 14 is a graphic diagram to explain a unit price of power charges based on an amount of power generated by a power company in the automated system for power retailing according to a sixth embodiment of the invention.

FIG. 15 is a diagram showing a data format of information about supply transmitted by the power company in the automated system for power retailing according to the sixth embodiment of the invention.

FIG. 16 is a graphic diagram to explain a table of unit price of power charges for each time zone of a power company in the automated system for power retailing according to an eighth embodiment of the invention.

FIG. 17 is a diagram showing a data format of information about supply transmitted by the power company in the automated system for power retailing according to the eight embodiment of the invention.

FIG. 18 is a graphic diagram to explain a table of unit price of power charges based on an amount of power generated by a power company in the automated system for power retailing according to a tenth embodiment of the invention.

FIG. 19 is a graphic diagram showing a total amount of power demand in an arbitrary number of power customers in the automated system for power retailing according to the tenth embodiment of the invention.

FIG. 20 is a flow chart showing an operation of the automated system for power retailing according to the tenth embodiment of the invention.

FIG. 21 is a graphic diagram to explain a table of unit price of power charges for each time zone of a power company in the automated system for power retailing according to an eleventh embodiment of the invention.

FIG. 22 is a graphic diagram showing an amount of power demand of an individual power customer in the automated system for power retailing according to the eleventh embodiment of the invention.

FIG. 23 is a flow chart showing an operation of the automated system for power retailing according to the eleventh embodiment of the invention.

FIG. 24 is a flow chart showing an operation of the automated system for power retailing according to a twelfth embodiment of the invention.

FIG. 25 is a flow chart showing an operation of the automated system for power retailing according to a thirteenth embodiment of the invention.

FIG. 26 is a graphic diagram showing a cost of power transmission based on a power transmission distance of each power company in the automated system for power retailing according to a fourteenth embodiment of the invention.

FIG. 27 is a diagram showing a data format of information about the cost of power transmission performed by the power company in the automated system for power retailing according to the fourteenth embodiment of the invention.

FIG. 28 is a flow chart showing an operation of the automated system for power retailing according to a fifteenth embodiment of the invention.

### DESCRIPTION OF THE PREFERRED EMBODIMENTS

Embodiment 1

A first preferred embodiment of the present invention is hereinafter described referring to the drawings.

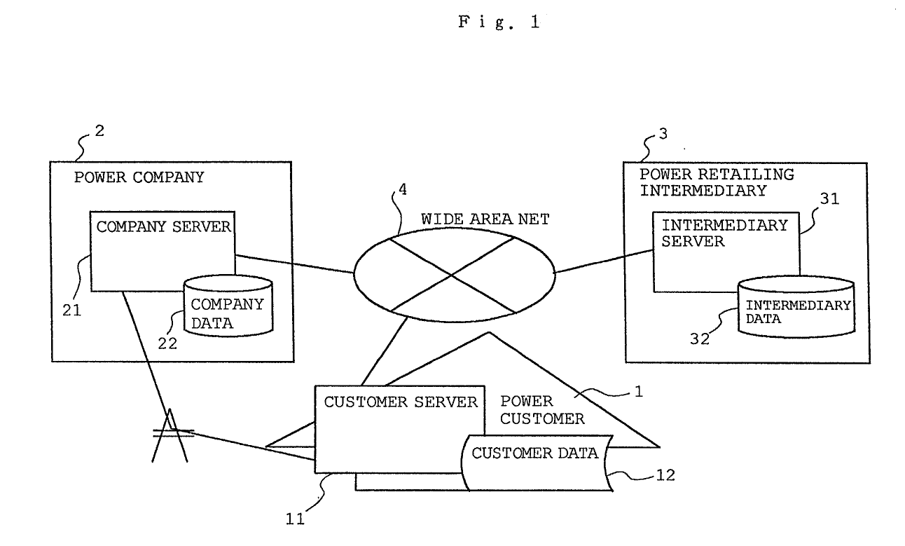

FIG. 1 is a diagram showing an arrangement of an automated system for power retailing according to the first embodiment of the invention.

In FIG. 1, reference numeral 1 is a power customer who consumes power. Numeral 11 is a customer server having a function capable of measuring power consumption. Numeral 12 is customer data consisting of information of power demand, and the like. Numeral 2 is a power company capable of generating power and supplying it. Numeral 21 is a company server. Numeral 22 is company data consisting of power supply information or power sale information, and the like. Numeral 3 is an intermediary agent for power retailing who intermediates a transaction of power between the power company 2 and the power customer 1. Numeral 31 is an intermediary server. Numeral 32 is intermediary data consisting of information about supply and demand of power, information about purchase and sale of power, and the like. Numeral 4 is a wide area net such as Internet for providing a connection between the customer server 11, the power company server 21, and the intermediary server 31.

In the arrangement shown in FIG. 1, the power customer 1 is provided with the customer server 11, the power company 2 is provided with the company server 21, and the intermediary agent for power retailing 3 is provided with the intermediary server 31. Further, they are respectively connected to the wide area net 4. The servers are to exchange information for the transaction of power, and exist independently of facilities for power transmission. Measurement of power supply amount is not conducted by measuring the power supplied from the power-transmission line as described in the known art shown in the Japanese Patent Publication (unexamined) No. 308771/1999, but conducted by a function of measuring power consumption incorporated in the customer server 11.

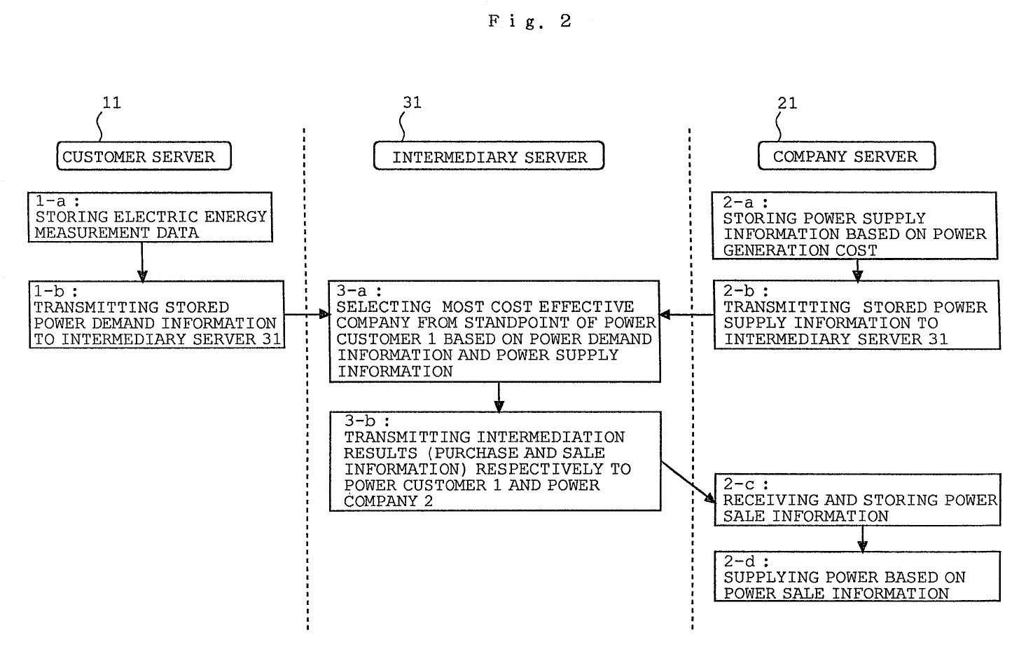

FIG. 2 is a flow chart showing an operation of the automated system for power retailing according to this first embodiment of this invention.

Now, the operation is described with reference to the flow chart in FIG. 2.

In the customer server 11, a power consumption output from a voltmeter is fetched in as time-series data, and the data are stored as information about power demand into the customer data 12 (1-a). The customer server 11 transmits the information about power demand stored for a predetermined period of time to the intermediary server 31 (1-b).

In the company sever 21, information about supply of power capable of being electrically supplied based on the power generation cost, is stored in the company data (2-a). The company server 21 transmits the information about power supply stored in the company data 22 to the intermediary server 31 (2-b).

The intermediary server 31 selects a most cost-effective power company 2 from the viewpoint of the power customer 1 on the basis of the information about power demand transmitted from the customer server 11 and the information about power supply transmitted from the company server 21 (3-a). Then, the intermediation results (information about purchase and sale) are transmitted to the power customer 1 and the power company 2 (3-b).

The company server 21 receives the information about power sale transmitted from the intermediary server 31 and stores it in the company data 22 (2-c). The company server 21 supplies power on the basis of the information about power sale in the company data 22 (2-d).

In this first embodiment, by conducting the above-mentioned procedures, the power company 2 can previously transmit information about power supply as data to the intermediary agent 3 for power retailing. Therefore, the trouble of participating in any auction can be saved. Furthermore, the intermediary agent 3 for power retailing can receive the data about power supply and power demand via the network so that a trouble of operating an auction can be saved. Since power consumption is automatically measured and the power company 2 is selected based thereon, the power customer 1 can purchase the optimum power for their own power demand.

Embodiment 2

A second preferred embodiment of the present invention is hereinafter described referring to the drawings.

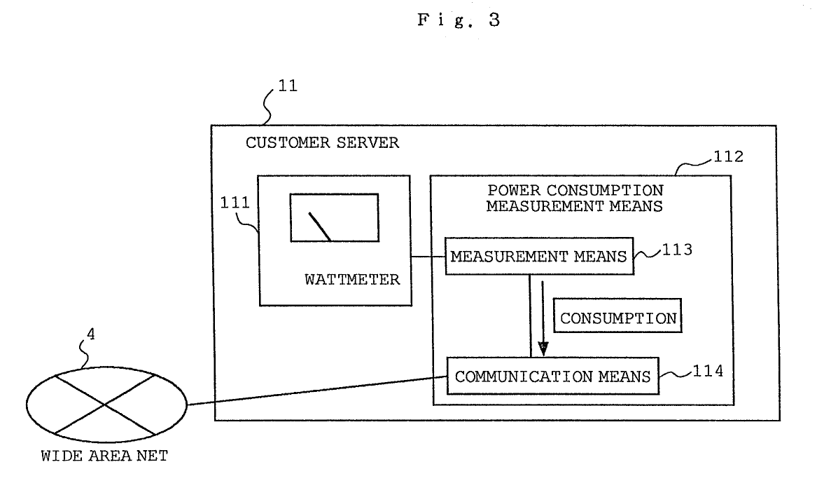

FIG. 3 is a diagram showing an arrangement of the customer server in the automated system for power retailing according to the second embodiment of the invention.

In FIG. 3, reference numeral 111 is a wattmeter provided at the power customer 1. Numeral 112 is power consumption measurement means linked with the wattmeter 111. Numeral 113 is measurement means for measuring electric energy that the power customer 1 has consumed. Numeral 114 is communication means for communicating the information measured and obtained by the measurement means 113 to the intermediary server 31 through the wide area net 4, and forms power consumption measurement means 112 together with measurement means 113.

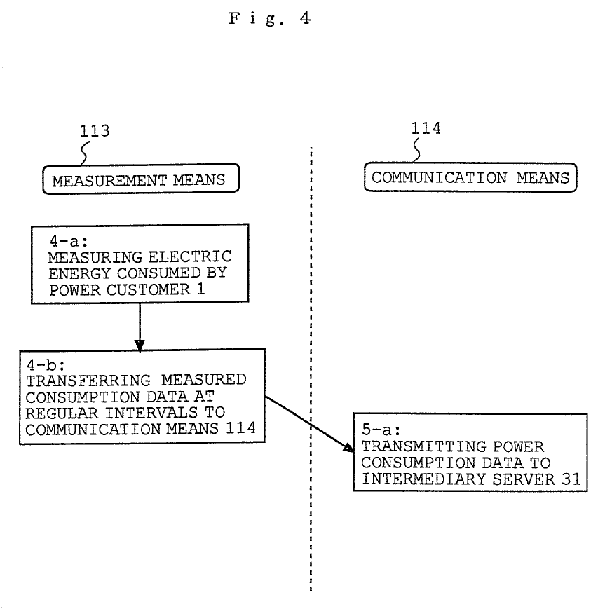

FIG. 4 is a flowchart showing an operation of the customer server in the automated system for power retailing according to the second embodiment of the invention.

Now, the operation is described with reference to the flow chart in FIG. 4.

In the measurement means 113, electric energy that the power customer 1 has consumed is measured at regularly fixed intervals (4-a). Data about measured consumption are transferred to communication means 114 (4-b).

In the communication means 114, the received information about power consumption is transmitted to the intermediary server 31 (5-a).

As described above, in this second embodiment, since power consumption is transmitted at regular intervals, no storage of data or the like is required thereby requiring no storage device or the like. Therefore, the power consumption measurement means can be formed at a low cost.

Embodiment 3

A third preferred embodiment is described referring to the drawings.

FIG. 5 is a diagram showing an arrangement of the customer server in the automated system for power retailing according to the third embodiment of the invention.

In FIG. 5, reference numeral 111 is a wattmeter provided at a house of the power customer 1. Numeral 112 is power consumption measurement means linked with the wattmeter. Numeral 113 is measurement means for measuring, at intervals of arbitrary length, electric energy that the power customer 1 has consumed. Numeral 114 is communication means for communicating, at set intervals, the information measured by measurement means 113 to the intermediary server 31 via the wide area net 4, and forms power consumption measurement means together with measurement means 113.

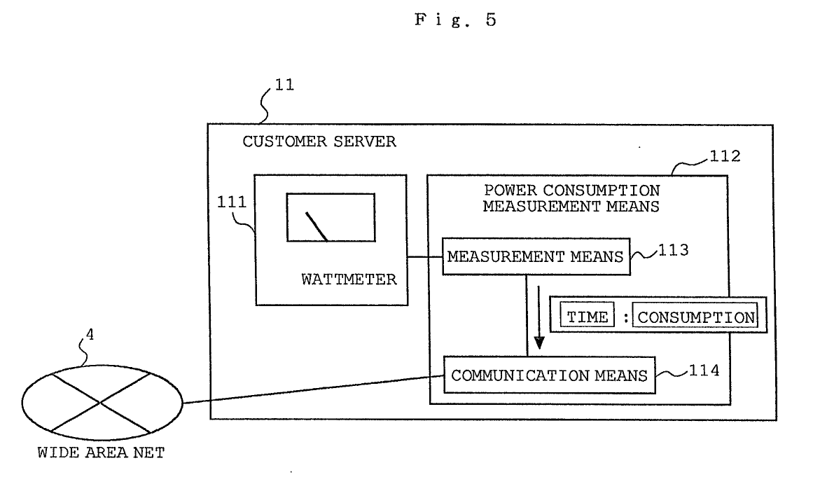

FIG. 6 is a flow chart showing an operation of the customer server in the automated system for power retailing according to the third embodiment of the invention.

Now, the operation is described with reference to the flow chart in FIG. 6.

In the measurement means 113, electric energy that the power customer 1 has consumed is measured at intervals of arbitrary length (4-a). Data about the measured consumption and time information are passed to communication means 114 (4-c).

In the communication means 114, an interval in communication to the intermediary server can be set, and it is judged whether or not the set interval be the set transmission interval (5-b). Then, after passing the set interval for transmission, connecting to the intermediary server 31, data about the power consumption and the time information are transmitted to the intermediary server 31 (5-c). After the transmission, the connection to the intermediary server 31 is cut off.

As described above, in this third embodiment, by making it possible to cut off the connection except the transmission time or to change setting of the communication interval, communication cost of the power customer can be reduced.

Embodiment 4

A fourth preferred embodiment of the present invention is described referring to the drawings.

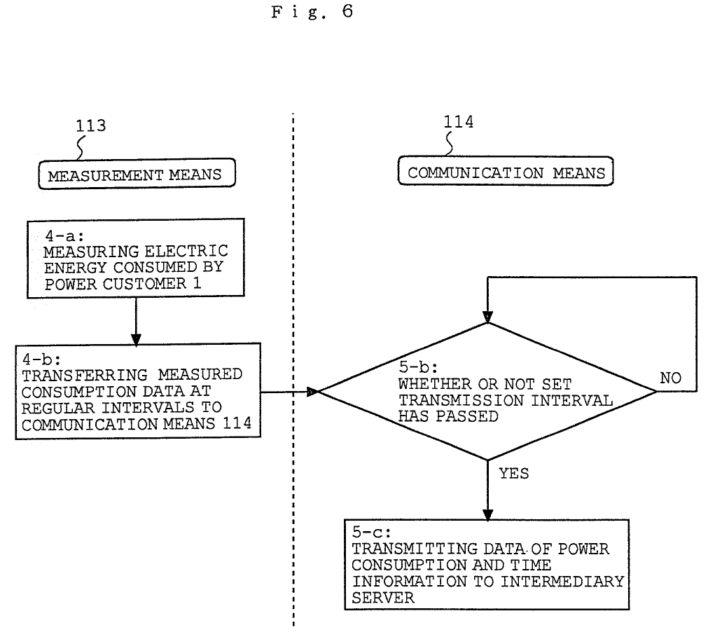

FIG. 7 is a diagram showing an arrangement of the customer server in the automated system for power retailing according to the fourth embodiment of the invention.

In FIG. 7, reference numeral 111 is a wattmeter provided at the power customer 1. Numeral 112 is power consumption measurement means liked with the wattmeter. Numeral 113 is measurement means for measuring, at intervals of arbitrary length, electric energy that the power customer 1 has consumed. Numeral 115 is recording means for recording information measured by measurement means 113 in a memory. Numeral 114 is communication means for communicating one block of the information recorded by the recording means 115 to the intermediary server 31 through the wide area net 4, and forms power consumption measurement means 112 together with the measurement means 113 and the recording means 115.

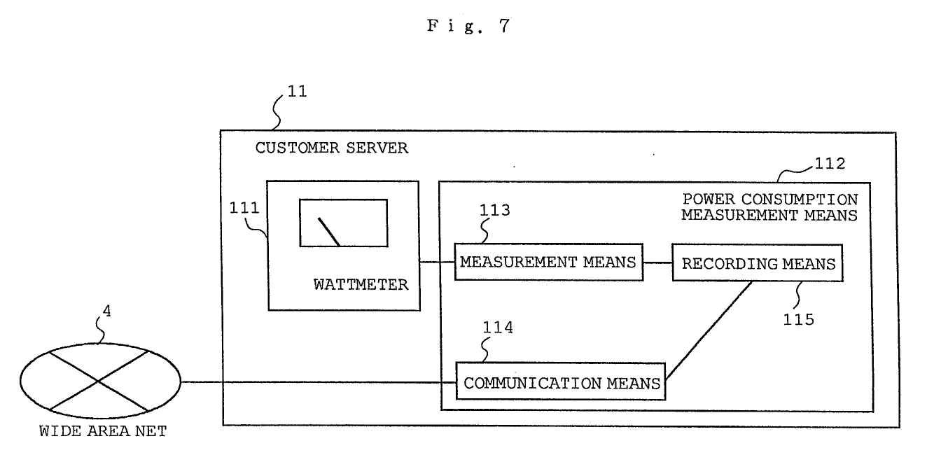

FIG. 8 is a diagram showing a data format stored in the recording means of the customer server in the automated system for power retailing according to the fourth embodiment of the invention.

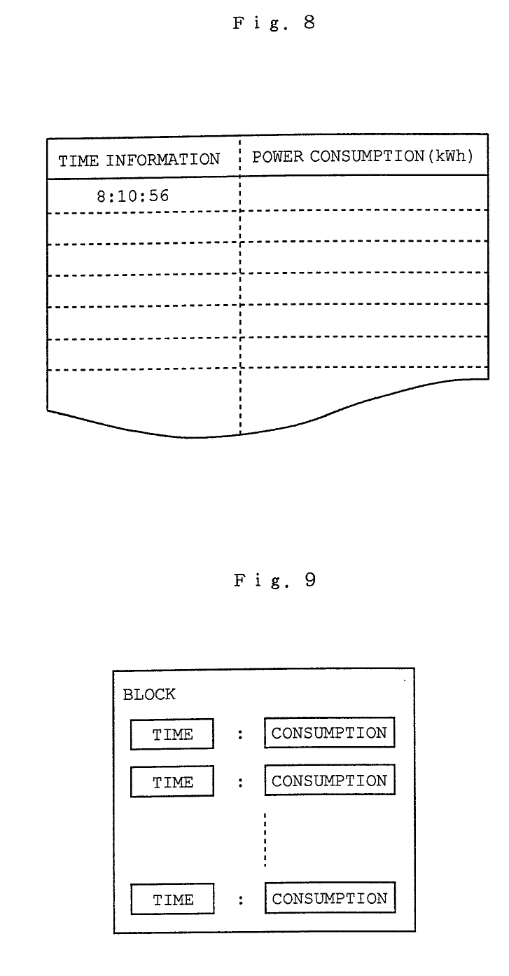

FIG. 9 is a diagram showing a communication form sent by the communication means of the customer server in the automated system for power retailing according to the fourth embodiment of the invention.

FIG. 10 is a flow chart showing an operation of the customer server in the automated system for power retailing according to the fourth embodiment of the invention.

Now, the operation is described with reference to the flow chart in FIG. 10.

In the measurement means 113, the time interval between recordings can be changed. Therefore, when measurement of electric energy consumed by the power customer 1 is started and the set time interval has passed (4-e), data about the measured consumption and the time information are transferred to the recording means 115 (4-f).

In the recording means 115, the data received from measurement means 113 are stored in the storage device such as memory in the format shown in FIG. 8 (6-a). Further, a mass (hereinafter referred to as a block) of data to be transmitted to the intermediary server 31 can be changed in volume. Thus, the data are fetched out in a block of volume as set (6-b). One block of fetched-out data is transferred to the communication means 114 (6-c).

In the communication means 114, time interval in communicating with the intermediary server can be set. Accordingly, when a set transmission interval has passed (5-b), by connecting to the intermediary server 31, one block of data is transmitted to the intermediary server 31 (5-d). After the transmission, the connection to the intermediary server 31 is cut off.

As described above, in this fourth embodiment, by storing data and making a transmission unit into a block, a time period keeping connection to the intermediary server can be reduced. Furthermore, since the time interval between recordings in recording means and the mass of data to be communicated can be changed in setting, communication cost can be reduced all the more than the foregoing third embodiment.

Embodiment 5

A fifth embodiment of the present invention is described referring to the drawings.

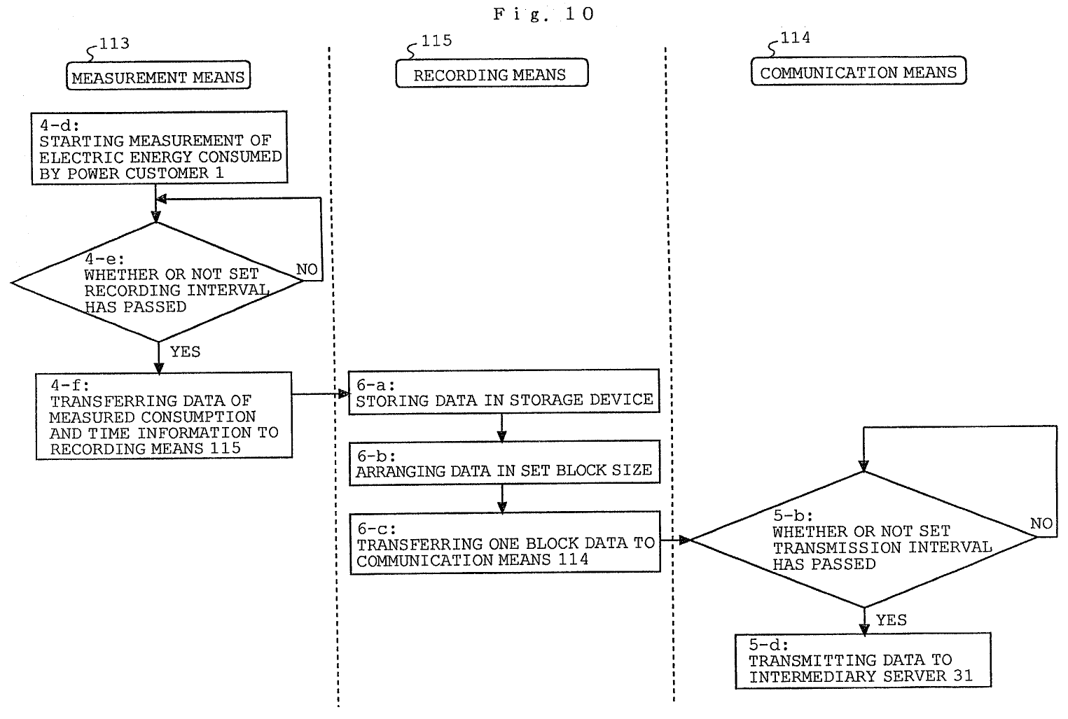

FIG. 11 is a diagram showing an arrangement of the customer server in the automated system for power retailing according to the fifth embodiment of the invention.

In FIG. 11, reference numeral 111 is a wattmeter provided at the power customer 1. Numeral 112 is power consumption measurement means liked with the wattmeter. Numeral 113 is measurement means for measuring electric energy that the power customer 1 has consumed. Numeral 115 is recording means for recording information measured by measurement means 113 in a storage device. Numeral 114 is communication means for communicating the information recorded by the recording means 115 to the intermediary server 31 through the wide area net 4. Numeral 116 is information about location, and forms power consumption measurement means 112 together with the measurement means 113, communication means 114 and recording means 115.

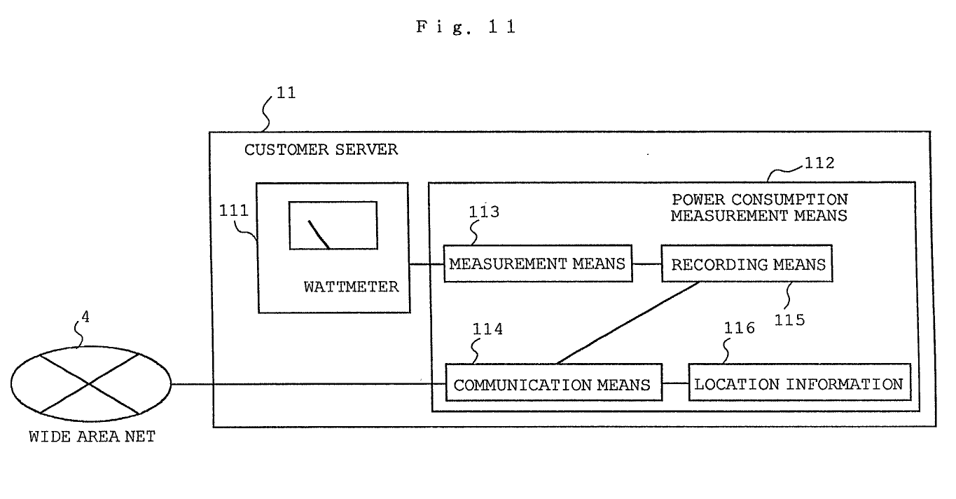

FIG. 12 is a flow chart showing an operation of the automated system for power retailing according to the fifth embodiment of the invention.

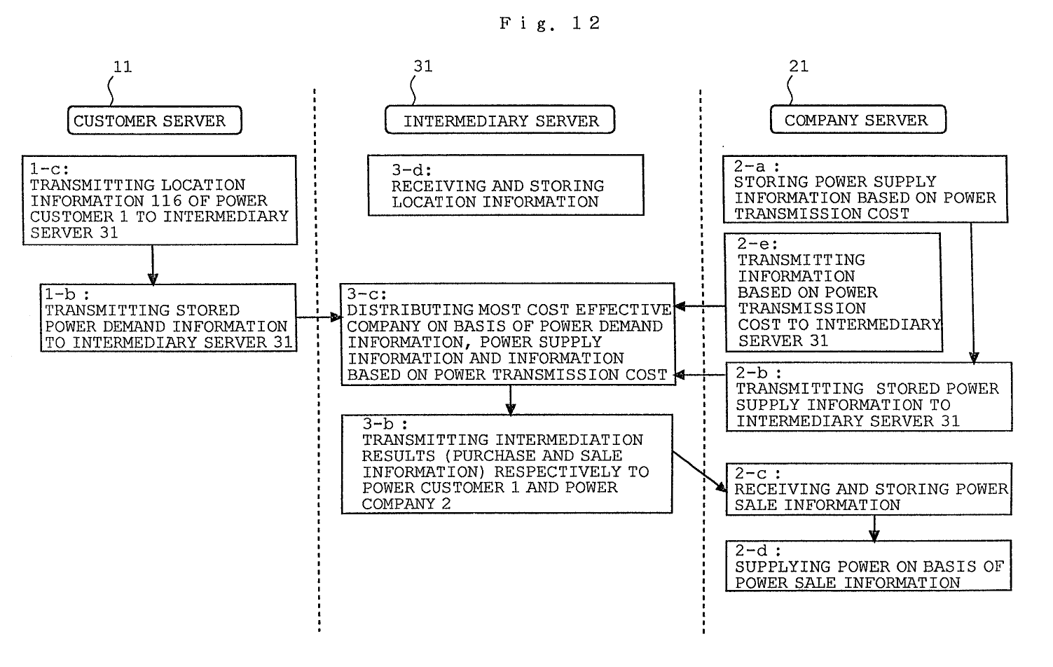

FIG. 13 is a flow chart showing an operation of the customer server in the automated system for power retailing according to the fifth embodiment of the invention.

Now, the operation is described with reference to the flow charts in FIGS. 12 and 13.

In the customer server 11, information about location of the customer server 1 is transmitted to the intermediary server 31 by the communication means 114 in the power consumption measurement means 112 (1-c) (5-e).

When measurement of electric energy consumed by the power customer 1 is started by measurement means 113 and a set time interval has passed, data about the measured consumption and the time information are transferred to the recording means 115 (4-f).

In the recording means 115, the data received from the measurement means 113 are stored in the format of FIG. 8 into the storage device such as memory (6-a). Further, a mass (hereinafter referred to as a block) of data to be transmitted to the intermediary server 31 can be changed in volume. Thus, the data are fetched out in a block of volume as set (6-b). One block of fetched-out data is transferred to the communication means 114 (6-c).

In the communication means 114, time interval in communicating with the intermediary server can be set. When the set interval for transmission has passed (5-b), by connecting to the intermediary server 31, one block of data is transmitted to the intermediary server 31 (5-d) (1-b). After the transmission, the connection to the intermediary server 31 is cut off.

In the company server 21, stored in the company data are information about supply of power capable of being supplied on the basis of power generation cost (2-a). The company server 21 transmits the information about power supply stored in the company data 22 to the intermediary server 31 (2-b). Further, the company server 21 transmits information in association with power transmission cost to the intermediary server 31 (2-e).

In the intermediary server 31, a most cost-effective power company from the standpoint of the power customer 1 is selected (3-c). This selection is conducted on the basis of the information about location (3-d) and the information about power demand transmitted from the customer server 11, and the information about power supply and the information based on the power transmission cost transmitted from the company server 21. Then, results of the intermediation (information about purchase and sale) are transmitted to the power customer 1 and the power company 2 (3-b).

The company server 21 stores the information about power sale transmitted from the intermediary sever 31 in the company data 22 (2-c). The company server 21 supplies power to the power customer 1 based on the information about power sale stored in the company data 22 (2-d).

When a power customer can select a power company to buy a power therefrom among a plurality of power companies 2 due to the liberalization of electric power, it is possible that a unit price of power charges of a remote power company 2 be more inexpensive. However, an additional cost may be produced depending on a distance between the power customer 1 and the power company 2. When a power transmission distance is long, in the case of adding the power-transmission cost to a unit price of power charges, it is possible that power of the other power company 2 may be more inexpensive.

Thus, in this fifth embodiment, by adding the power-transmission cost to the conditions for selecting the power company, the power customer can purchase the power most favorable to its own power demand considering the power-transmission cost.

Embodiment 6

A sixth embodiment of the invention is described referring to the drawings.

FIG. 14 is a graphic diagram to explain a table of a unit price of power charges based on an amount of power generated by the power company in the automated system for power retailing according to the sixth embodiment of the invention.

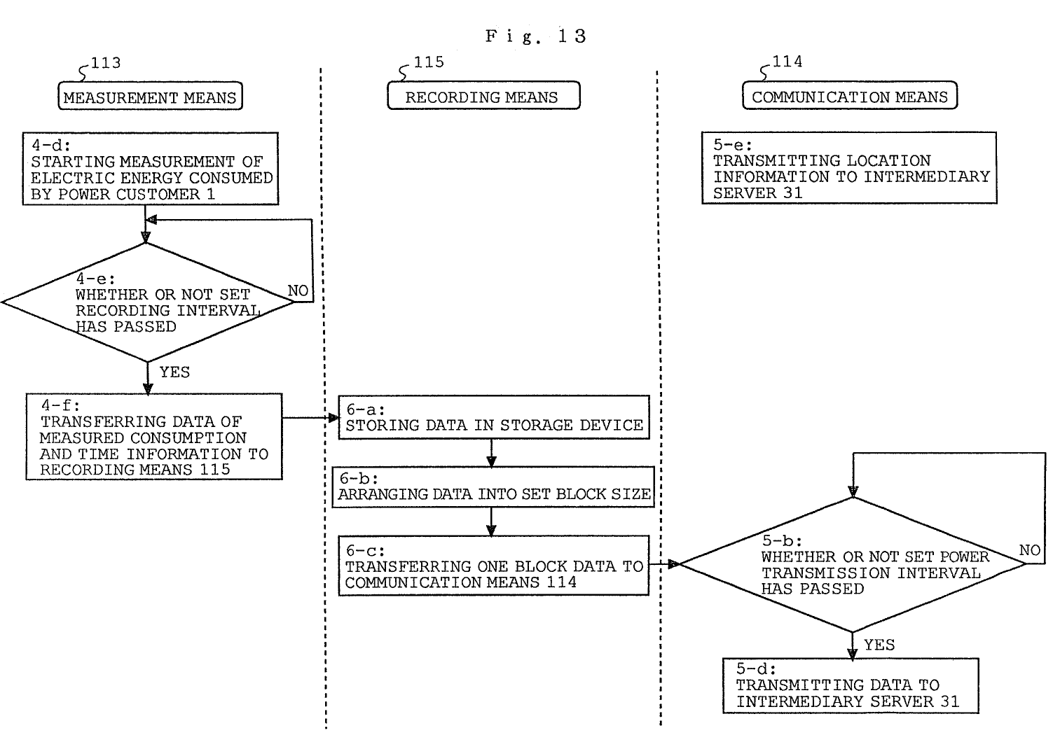

FIG. 15 is a diagram showing a data format of supply information transmitted by the power company in the automated system for power retailing according to the sixth embodiment of the invention.

In this sixth embodiment, the power company supplies a table of unit price of power charges in a data format as shown in FIG. 15. In the table, unit price is established to be lower as amount of power generation increases as shown in FIG. 14,

In this sixth embodiment, on the basis of the table of a unit price of power charges as shown in FIG. 14, the power customer can select a favorable power company.

Embodiment 7

As supply information transmitted by the power company 2, instead of using the table of unit price of power charges in FIG. 14, it is also preferable that functions in the following equations are employed to calculate a unit price of power charges based on an amount of power generation, thereby substantially the same effect being obtained.

P=f1(g)

(g11<g≦g12)

P=f2(g)

(g21<g≦g22)

where: P indicates a price, g indicates a power- generation amount, and (gn<g≦gn+1) indicates a section.

In this seventh embodiment, the power company transmits information about power supply set using the functions whereby power customer can select a favorable power company.

Embodiment 8

An eighth embodiment of the present invention is described referring to the drawings.

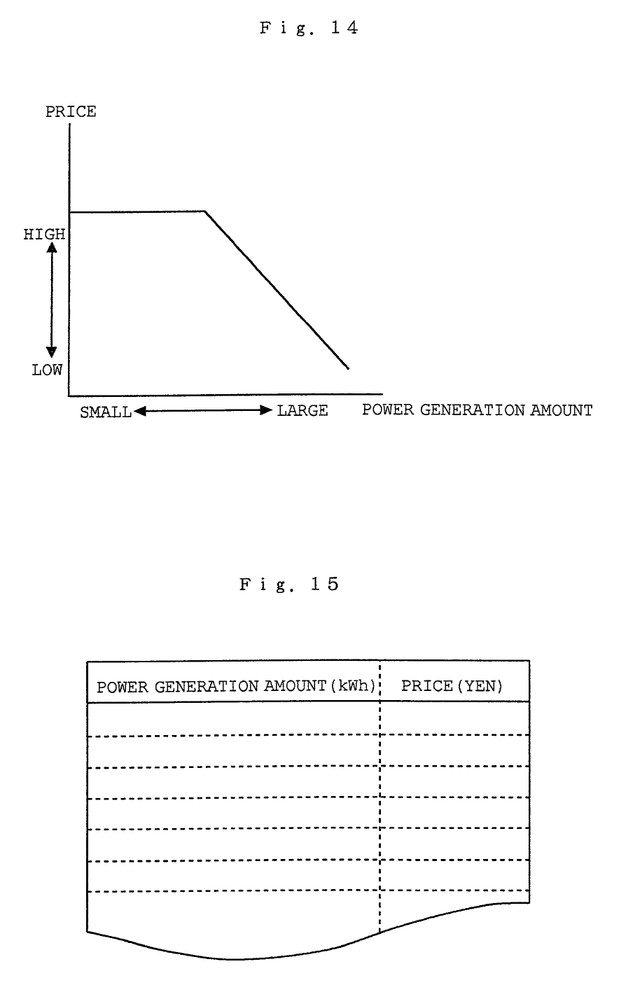

FIG. 16 is a graphic diagram to explain a table of unit price of power charges for each time zone of the power company in the automated system for power retailing according to the eighth embodiment of the invention.

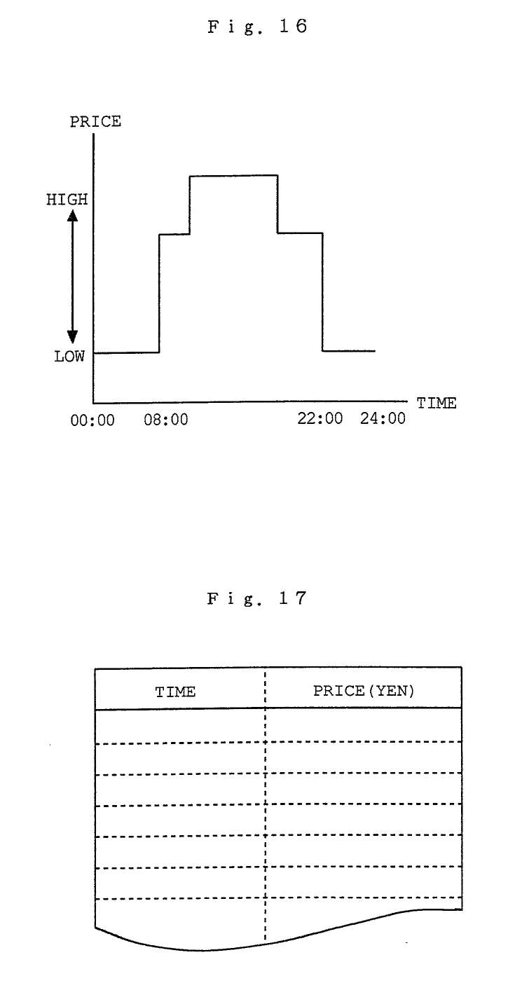

FIG. 17 is a diagram showing a data format of supply information transmitted by the power company in the automated system for power retailing according to the eighth embodiment of the invention.

In this eighth embodiment, as shown in FIG. 16, the power company provides a table of unit price of power charges set respectively for each time zone in the data format of FIG. 17.

In the foregoing sixth and seventh embodiments, matching is possible only with respect to a total demand in an arbitrary number of power customers, while in this eighth embodiment, matching is possible with respect to a demand of each individual customer.

In this eighth embodiment, by using the table of unit price of power charges set respectively for each time zone, the power customer can select a favorable power company.

Embodiment 9

As supply information transmitted by the power company 2, instead of using the table of a unit price of power charges in FIG. 16, it is also preferable that functions in the following equations are employed to calculate a unit price of power charges for each time zone, thereby substantially the same effect being obtained.

P=f1(t)

(t11<t≦t12)

P=f2(t)

(t21<t≦t22)

where: P indicates a price, t indicates a time, and (tn<t≦tn+1) indicates a section.

In this ninth embodiment, on the basis of the information about power supply set utilizing the functions by the power company, the power customer can select a favorable power company.

Embodiment 10

A tenth embodiment of the invention is described referring to the drawings.

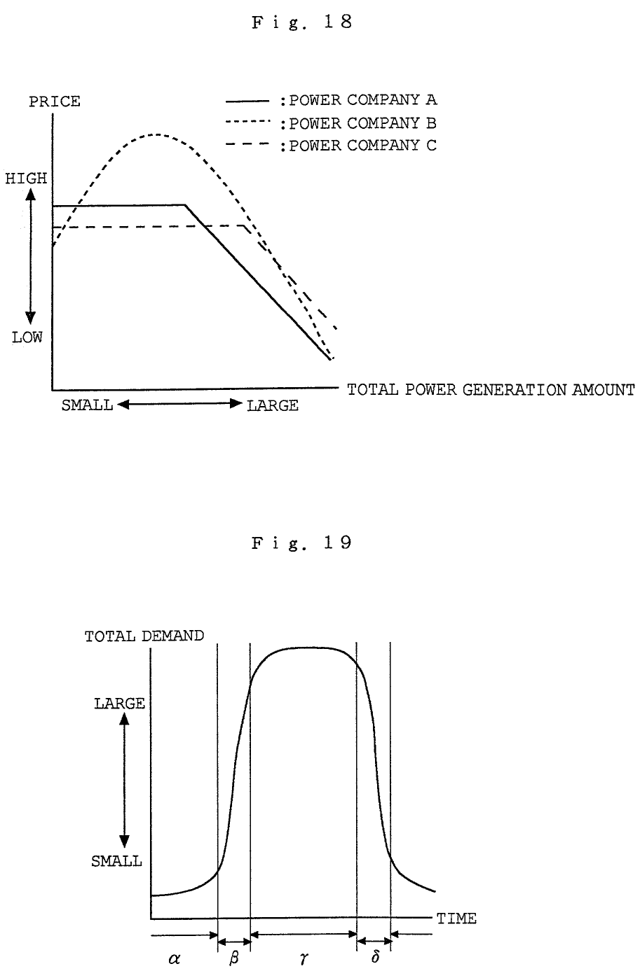

FIG. 18 is a graphic diagram to explain a table of unit price of power charges based on an amount of power generated by the power company in the automated system for power retailing according to the tenth embodiment of the invention.

FIG. 19 is a graphic diagram showing a total amount of power demand in an arbitrary number of power customers in the automated system for power retailing according to the tenth embodiment of the invention.

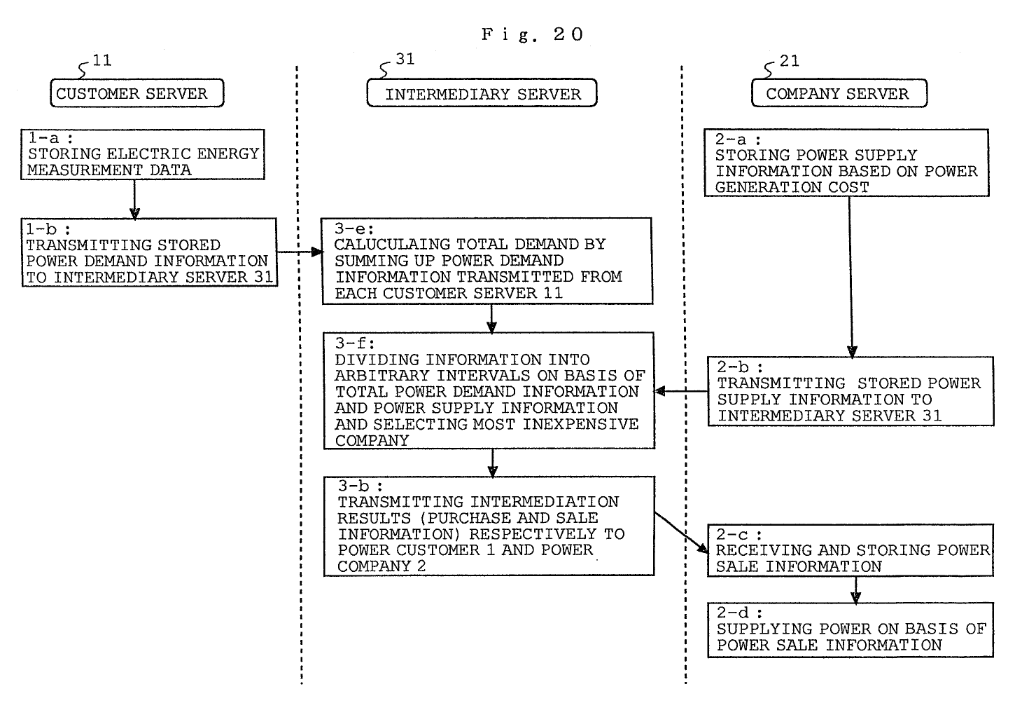

FIG. 20 is a flow chart showing an operation of the automated system for power retailing according to the tenth embodiment of the invention.

In this tenth embodiment, the power company is dynamically selected for each of divided sections formed by dividing a time period of the power customers, corresponding to the total amount of power demand in an arbitrary number of the power customers 1

Now, the operation is described with reference to the flow chart in FIG. 20.

In the customer server 11, a power consumption output from a voltmeter is fetched in as time-series data, and the data are stored in the customer data 12 as information about power demand (1-a). The customer server 11 transmits the information about power demand stored for a predetermined period of time to the intermediary server (1-b).

In the company server 21, information about supply of power capable of being electrically supplied based on an amount of power generation, is stored in the company data (2-a). The company server 21 transmits the information about power supply stored in the company data 22 to the intermediary server (2-b).

In the intermediary server 31, summing up the information about power demand transmitted from each customer server 11, a total amount of power demand in an arbitrary number of customers is calculated (3-e). The intermediary server 31, on the basis of the information about the total power demand calculated as described above and the information about power supply transmitted from the company server 21, divides the time period of the power customers into sections of arbitrary length as shown in FIG. 19. Then, a most cost-effective power company 2 from the standpoint of the power customer 1 for each divided section is selected (3-f). The intermediation results (information about purchase and sale) are transmitted to the power customer 1 and the power company 2 (3-b).

The company server 21 receives and stores the information about power sale transmitted from the intermediary server 31 into the company data 22 (2-c). The company server 21 supplies power to the power customer 1 based on the information about power sale in the company data 22 (2-d).

In this tenth embodiment, based on the total demand in an arbitrary number of power customers, a most inexpensive power company for each of divided sections formed by dividing the time period of the power customers can be selected.

Embodiment 11

An eleventh embodiment of the invention is described referring to the drawings.

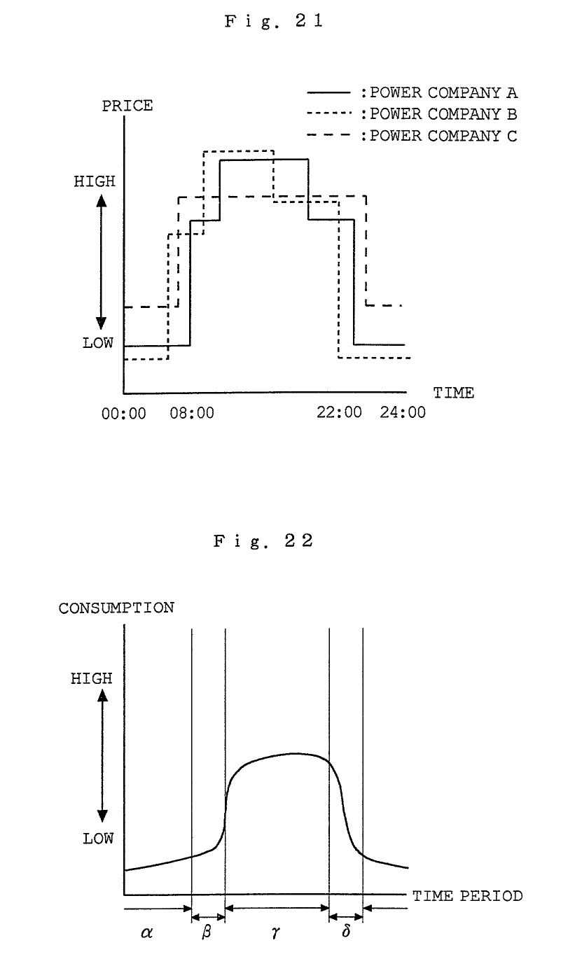

FIG. 21 is a graphic diagram to explain a table of unit price of power charges for each time zone of the power company in the automated system for power retailing according to the eleventh embodiment of the invention.

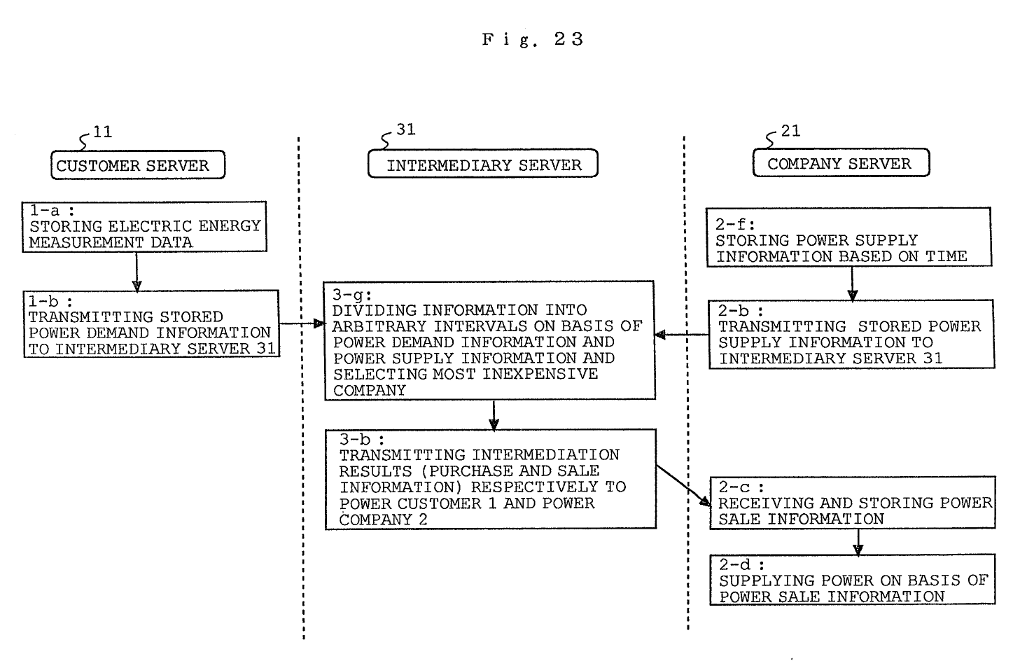

FIG. 22 is a graphic diagram showing an amount of power demand of an individual power customer in the automated system for power retailing according to the eleventh embodiment of the invention.

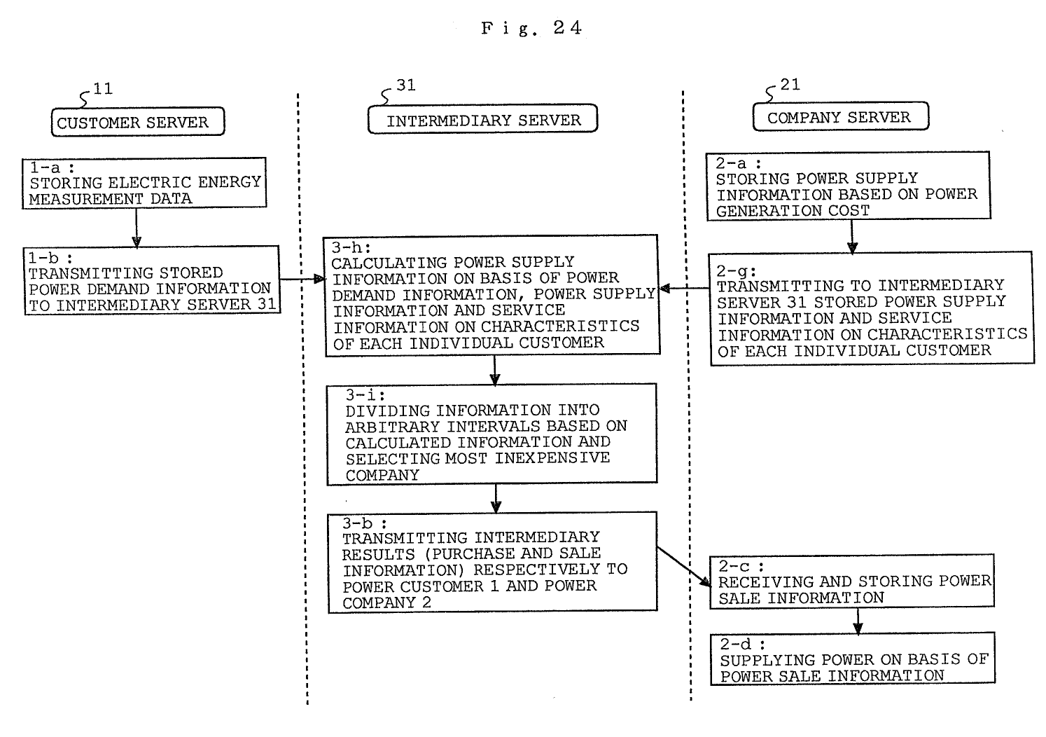

FIG. 23 is a flow chart showing an operation of the automated system for power retailing according to the eleventh embodiment of the invention.

In this eleventh embodiment, on the basis of a price set for each time zone by each power company, the power customer dynamically selects a power company for each of divided sections formed by dividing the time period.

Now, the operation is described with reference to the flow chart in FIG. 23.

In the customer server 11, a power consumption output from a voltmeter is fetched in as time-series data, and the data are stored in the customer data 12 as information about power demand (1-a). The customer server 11 transmits the information about power demand stored for a predetermined period of time to the intermediary server 31 (1-b).

In the company server 21, the information about power supply respectively for each time zone is stored in the company data (2-f). The company server 21 transmits the information about power supply stored in the company data 22 to the intermediary server (2-b).

The intermediary server 31, on the basis of the information about power demand transmitted from the customer server 11 and the information about power supply transmitted from the company server 21, divides the time period of the power customers into sections of arbitrary length as shown in FIG. 22. Further, a most cost-effective power company 2 from the standpoint of the power customer 1 for each divided section is selected (3-g). Then, intermediary results (sales and purchase information) are transmitted to the power customer 1 and the power company 2 (3-b).

The company server 21 receives the information about power sale transmitted from the intermediary server 31 and stores it in the company data 22 (2-c). The company server 21 supplies power to the power customer 1 based on the information about power sale in the company data 22 (2-d).

In the foregoing tenth embodiment, a power company 2 is selected based on a total amount of power demand in an arbitrary number of power customers 1. Therefore, the best-conditioned power company 2 for each divided section is not always selected from the standpoint of each power customer 1. However, in this eleventh embodiment, matching is conducted corresponding to the supply information for each time zone. Therefore, the customer can individually select a company, whereby a power company most favorable for each divided section from the standpoint of each power customer 1 is selected.

Embodiment 12

FIG. 24 is a flow chart showing an operation of the automated system for power retailing according to a twelfth embodiment of the invention.

When a power customer can select a power company to buy a power therefrom among a plurality of power companies 2 due to liberalization of electric power, it is conceivable that a discount (reduction in price) be provided depending on such conditions as contract period, amount of use, type of contract, etc. In this twelfth embodiment, such price reduction adapted to characteristics of each customer is incorporated as an element of judgement in selecting a company.

By weighting the information about power supply transmitted from the company server 21 with any service information on characteristics of each individual customer, an appropriate unit price of power charges for each time zone for each individual power customer 1 is calculated. Therefore the optimum power for personal demand for power can be purchased.

Now, the operation is described with reference to FIG. 24.

In the customer server 11, a power consumption output from a voltmeter is fetched in as time-series data, and the data are stored in the customer data 12 as information about power demand (1-a). The customer server 11 transmits the information about power demand stored for a predetermined period of time to the intermediary server 31 (1-b).

In the company server 21, the information about supply of power capable of being electrically supplied based on power-generation cost is stored in the company data (2-a). The company server 21 transmits to the intermediary server 31 the information about power supply stored in the company data 22 and the service information on the characteristics of each individual customer such as contract period, amount of use, type of contract, etc. (2-g).

In the intermediary server 31, by weighting the information about power supply transmitted from the company server 21 with any service information on the characteristics of each individual customer, an appropriate unit price of power charges for each time zone for the individual power customer 1 is computed (3-h). The intermediary server 31, on the basis of the information about a unit price of power charges computed as described above and the information about power demand transmitted from the power customer 1, divides the time period of the power customers into sections of arbitrary length. Further, a most cost-effective power company 2 from the standpoint of the power customer 1 for each divided section is selected (3-i). Then, intermediary results (information about purchase and sale) are transmitted to the power customer 1 and the power company 2 (3-b).

The company server 21 stores the information about power sale transmitted from the intermediary server 31 in the company data 22 (2-c). The company server 21 supplies power to the power customer 1 on the basis of the information about power sale stored in the company data 22 (2-d).

In this twelfth embodiment, a power company can be selected respectively based on the service information of each individual power customer.

Embodiment 13

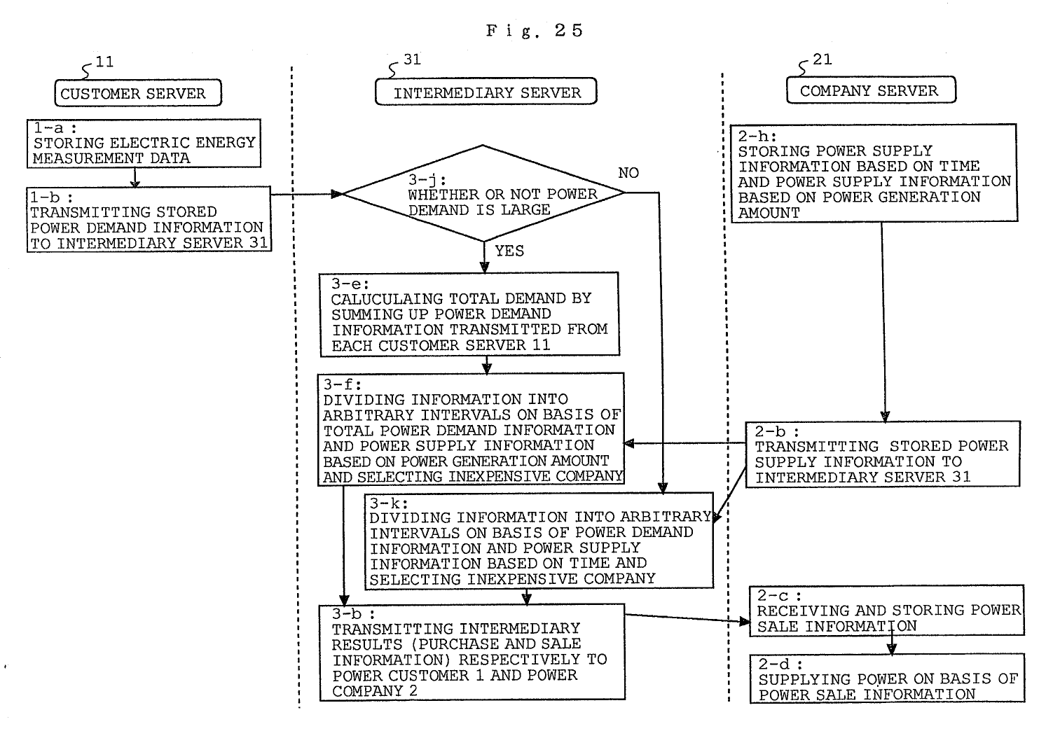

FIG. 25 is a flow chart showing an operation of the automated system for power retailing according to the thirteenth embodiment of the present invention.

In this thirteenth embodiment, in the case of a large-volume customer, on the basis of a total amount of power demand in an arbitrary number of power customers, a power company is selected for each of divided sections formed by dividing time period of the power customers. Whereas, in the case of a small-volume customer, on the basis of information of power supply in time each zone of power companies, a power company is selected for each of divided sections of the power customers.

The thirteenth embodiment of the invention is described with reference to the flow chart in FIG. 25.

In the customer server 11, a power consumption output from a voltmeter is fetched in as time-series data, and the data are stored in the customer data 12 as information about power demand (1-a). The customer server 11 transmits the information about power demand stored for a predetermined period of time to the intermediary server 31 (1-b).

In the company server 21, stored into the company data is the information about power supply for each time zone and the information about power supply based on power-generation amount (2-h). The company server 21 transmits the information about power supply for each time zone as well as based on power-generation amount stored in the company data 22 to the intermediary server 31 (2-b).

In the intermediary server 31, the power customers 1 are divided into large-volume customers and small-volume customers depending on amount of power demand on the basis of the information about the power demand transmitted from the power customer 1 (3-j). In the case of being judged a large-volume customer in the mentioned manner, in the intermediary server 31, a total amount of power demand in an arbitrary number of customers is calculated by summing up the information about power demand transmitted from each customer server 11 (3-e). The intermediary server 31, on the basis of the information about the total amount of power demand calculated as mentioned above and the information about power supply based on an amount of power generation transmitted from the company server 21, divides the time period of the power customers into sections of arbitrary length as shown in FIG. 19. Then, the intermediary server 31 selects a most cost-effective power company 2 from the standpoint of the power customer 1 for each divided section (3-f).

In the case of being judged a small-volume customer, on the basis of the information about the power demand transmitted from the customer server 11 and the information about power supply for each time zone transmitted from the company server 21, the intermediary server 31 divides the time period of the power customers into sections of arbitrary length as shown in FIG. 22. Then, the intermediary server 31 selects a most cost-effective power company from the standpoint of the power customer 1 for each divided section (3-k). Then, intermediary results (information about purchase and sale) are transmitted to the power customer 1 and the power company 2 (3-b).

The company server 21 receives the information about power sale transmitted from the intermediary server 31 and stores it in the company data 22 (2-c). The company server 21 supplies power to the power customer 1 on the basis of the information about power sale stored in the company data 22 (2-d).

In this thirteenth embodiment, the data used in selecting the power company 2 depending on an amount of power demand of the power customer 1, can be replaced. Therefore, a most favorable power company is selected for each divided section from the standpoint of each individual power customer 1.

Embodiment 14

A fourteenth embodiment of the invention is described referring to the drawings.

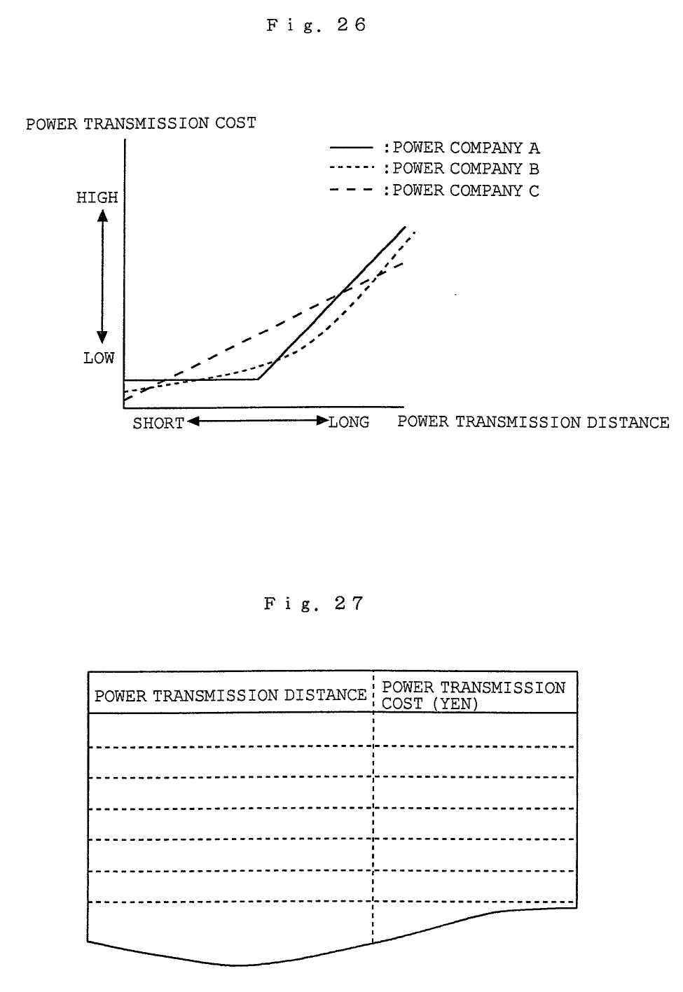

FIG. 26 is a graphic diagram showing cost of power transmission based on distance of power transmission of each power company in the automated system for power retailing according to the fourteenth embodiment of the invention.

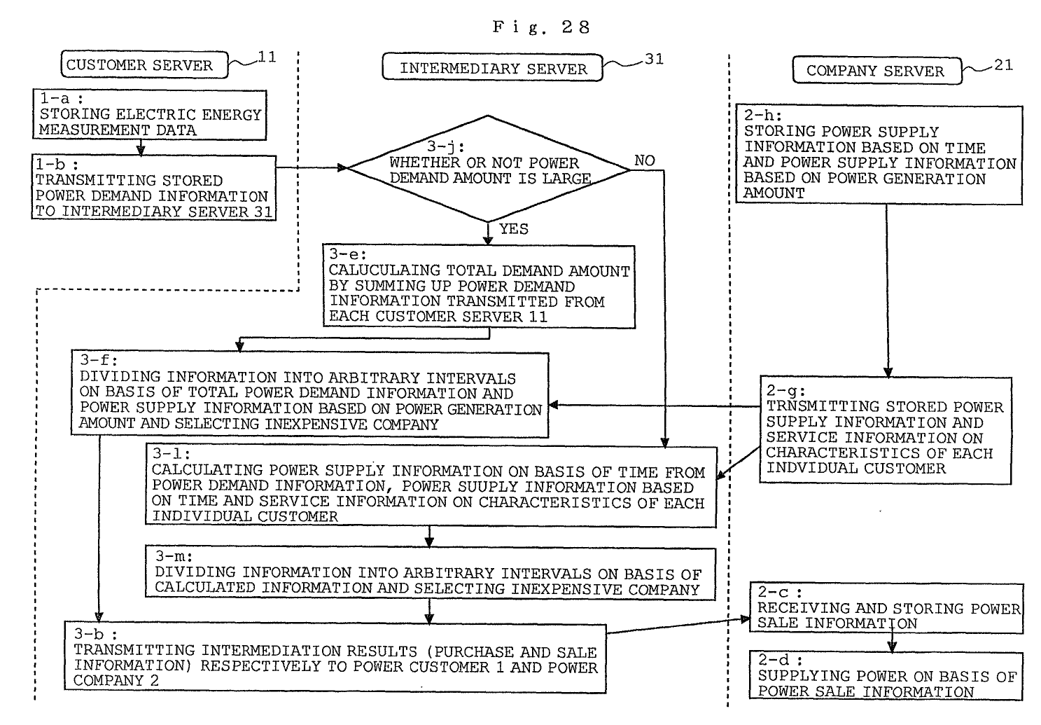

FIG. 27 is a diagram showing a data format of the information about the power-transmission cost transmitted by the power company in the automated system for power retailing according to the fourteenth embodiment of the invention.

When a power customer can select a power company to buy a power therefrom among a plurality of power companies 2 due to liberalization of electric power, since a distance of power transmission varies depending on each power company, the power-transmission cost will vary. In order to select an optimum power company for power demand of the power customer 1, not only a price unit of power charges of the power company 2 but also the information about the power-transmission cost is required. The information about the power-transmission cost is computed utilizing information on location of the power customer.

In the fourteenth embodiment, also adding the power-transmission cost shown in FIG. 26 to a unit price of power charges, a power company of inexpensive charges is selected.

In this fourteenth embodiment, a power company can be selected considering a power-transmission cost in addition to a unit price of power charges.

Embodiment 15

FIG. 28 is a flow chart showing an operation of the automated system for power retailing according to a fifteenth preferred embodiment of the invention.

In this fifteenth embodiment, in the case of a large-volume customer, on the basis of a total amount of power demand in an arbitrary number of power customers, a power company is selected for each divided section of the power customers. Whereas in the case of a small-volume customer, on the basis of the individual service information as described in the fore going twelfth embodiment, a power company is selected for each divided section of the time period of the power customers.

Now, the fifteenth embodiment is described with reference to the flow chart in FIG. 28.

In the customer server 11, a power consumption output from a voltmeter is fetched in as time-series data, and the data are stored as information about power demand in the customer data 12 (1-a). The customer server 11 transmits the information about power demand stored for a predetermined period of time to the intermediary server 31 (1-b).

In the company server 21, the information about power supply for each time zone and the information about power supply based on an amount of power generation are stored in the company data (2-h). The company server 21 transmits to the intermediary server 31 the information about power supply stored in the company data 22 and the service information on the characteristics of each individual customer such as contract period, amount of use, type of contract, etc. (2-g).

In the intermediary server 31, the power customers are divided into large-volume customers and small-volume customers depending on amount of power demand based on the information about power demand transmitted from the power customer 1 (3-j). In the case of being judged a large-volume customer as mentioned above, in the intermediary server 31, a total amount of power demand in an arbitrary number of customers is computed summing up the information about power demand transmitted from each customer server 11 (3-e). The intermediary server 31, on the basis of the information about the total demand computed as mentioned above and the information about power supply based on an amount of power generation transmitted from the company server 21, divides the time period of the power customers into sections of arbitrary length as shown in FIG. 19. Then, the intermediary server 31 selects a most cost-effective power company 2 from the standpoint of the power customer 1 for each divided section (3-f).

In the case of being judged a small-volume customer, in the intermediary server 31, by weighting the information about power supply transmitted from the company server 21 with any service information on the characteristics of each individual customer, computed is an appropriate unit price of power charges for each time zone of each individual power customer 1 (3-l). The intermediary server 31, on the basis of the information about power charges computed as mentioned above and the information about power demand transmitted from the power customer 1, divides the time period of the power customers into sections of arbitrary length as shown in FIG. 22. Then, the intermediary server 31 selects a most cost-effective power company 2 from the standpoint of the power customer 1 for each divided section (3-m). Intermediary results (information about purchase and sale) are transmitted to the power customer 1 and the power company 2 (3-b).

The company server 21 receives the information about power sale transmitted from the intermediary server 31 and stores it in the company data 22 (2-c). The company server 21 supplies power to the power customer 1 on the basis of the information about power sale in the company data 22 (2-d).

In the fifteenth embodiment, by weighting with any service information on the characteristics of each power customer except the judgment in the foregoing thirteenth embodiment, an appropriate unit price of power charges for each time zone is computed for each power customer. Therefore, each individual power customer can purchase more optimum power for its own power demand than in the foregoing thirteenth embodiment.

What is claimed is:

1. An automated system for power retailing comprising an intermediary server, to which inputted through a network are power supply information about a power capable of being supplied by a power company including information about electric power charge, and information about power demand that is an information about power consumption of a power customer who consumes power;
wherein said intermediary server, by selecting said power company suitable for said power customer on the basis of said inputted information about power supply and power demand, intermediates a transaction of power between said power company and said power customer.

2. The automated system for power retailing according to claim 1, further comprising a company server that is connected to said intermediary server through said network and transmits the information about power supply of said power company to said intermediary server.

3. The automated system for power retailing according to claim 1, further comprising a customer server that is connected to said intermediary server through said network, includes power consumption measurement means for measuring a power consumption of the power customer, and transmits information about the power consumption measured by said power consumption measurement means to said intermediary server.

4. The automated system for power retailing according to claim 3, wherein said power consumption measurement means includes: measurement means for measuring at intervals of a predetermined length an amount of power consumed by the power customer; and communication means for transmitting the information about the power consumption measured by said measurement means to said intermediary server.

5. The automated system for power retailing according to claim 3, wherein said power consumption measurement means includes: measurement means for measuring at intervals of an arbitrary length an amount of power consumed by the power customer; and communication means for transmitting at intervals of a predetermined length the information about the power consumption measured by said measurement means to said intermediary server.

6. The automated system for power retailing according to claim 3, wherein said power consumption measurement means includes: measurement means for measuring at intervals of an arbitrary length an amount of power consumed by the power customer; recording means for recording information about the power consumption measured by said measurement means; and communication means for transmitting in a predetermined block the information about the power consumption recorded by said recording means to said intermediary server.

7. The automated system for power retailing according to claims 1, wherein said power supply information contains a unit price of power charges corresponding to an amount of power generated by the power company; said power customers are plural; and said intermediary server selects a power company on the basis of a total amount of the power consumption of said plural power customers.

8. The automated system for power retailing according to claim 7, wherein said intermediary server selects a power company for each divided section of time period of said power customers.

9. The automated system for power retailing according to claims 1, wherein said power supply information contains a unit price of power charges set for each time zone of said power company; and said intermediary server, based on the unit price of power charges for each time zone of said power company, selects a power company for each divided section of time period of said power customer.

10. The automated system for power retailing according to claims 1, wherein service information is set individually for said power customer and said intermediary server selects a power company by using the service information set individually for said power customer.

11. The automated system for power retailing according to claims 1, wherein said intermediary server selects a power company by a selection method corresponding to the power consumption of said power customer.

12. The automated system for power retailing according to claim 11, wherein said power supply information contains a unit price of power charge corresponding to the amount of power generated by said power company, said power customers are plural, and said intermediary server selects a power company for each divided section of time period of said power customer for the power customer consuming a large-volume of power based on the total amount of the power consumption of said plural power customers.

13. The automated system for power retailing according to claim 11, wherein said power supply information contains a unit price of power charge set for each time zone of said power company; and said intermediary server selects a power company for each divided section of time period of said power customer for the power customer consuming a small-volume of power based on a unit price of power charges set for each time zone of said power company.

14. The automated system for power retailing according to claim 11, wherein service information is set individually for said power customer, and that said intermediary sever selects a power company for the power customer consuming a small-volume of power for each divided section of time period of said power customer using the service information set individually for said power customer.

15. The automated system for power retailing according to claim 7, wherein said information about power supply contains a table showing a unit price of power charges in which a unit price of power charges is set corresponding to the amount of power generated by said power company.

16. The automated system for power retailing according to claim 7, wherein said information about power supply contains a function for calculating a unit price of power charges based on the amount of power generated by said power company.

17. The automated system for power retailing according to claim 9, wherein said information about power supply contains a table showing a unit price of power charges set for each time zone.

18. The automated system for power retailing according to claim 9, wherein said information about power supply contains a function for calculating a unit price of power charges with the use of time.

19. The automated system for power retailing according to claims 1, wherein said information about power demand contains information about location of said power customer, and said information about power supply contains information about power transmission cost of said power company.

20. The automated system for power retailing according to claim 19, wherein said intermediary server selects a power company using information about location contained in said information about power demand and the information about power generation cost contained in said information about power supply.
